(19) United States
(12) Patent Application Publication
(10) Pub. No.: US 2015/0193399 A1
(43) Pub. Date: Jul. 9, 2015

(54) METHOD AND APPARATUS FOR DETERMINING PARTIAL UPDATES FOR A DOCUMENT OBJECT MODEL

(71) Applicant: NOKIA CORPORATION, ESPOO (FI)

(72) Inventors: Clint Willliam Henry WOKER, St. Charles, IL (US); Peter Allen GOREHAM, Mt. Prospect, IL (US); Gregory Joseph ATHAS, Lisle, IL (US); Thomas William ARRA, Downers Grove, IL (US)

(73) Assignee: NOKIA CORPORATION, ESPOO (FI)

(21) Appl. No.: 14/151,472

(22) Filed: Jan. 9, 2014

(51) Int. Cl. G06F 17/22; H04L 12/24

(52) U.S. Cl. CPC G06F 17/2247; H04L 41/02

(57) ABSTRACT

An approach is provided for temporal registration of modifications in a document object model (DOM) and providing an efficient update to the DOM. A web content rendering engine processes and/or facilitates a processing of event data resulting from at least one interaction with a document object model to determine at least one modification to at least one node of the document object model. The web content rendering engine also causes a registration of the at least one modification with respect to a temporal parameter. Further, the web content rendering engine causes a generation of at least one content change result list for the document object model based, at least in part, on the registration. Furthermore, the web content rendering engine causes a transmission of the at least one content change result list to at least one proxy client for updating of the document object model.

### BACKGROUND

Wireless (e.g., cellular) service providers and device manufacturers are continually challenged to deliver value and convenience to consumers by, for example, providing compelling network services, applications, and content. One area of interest is providing user access to content and services available via a plethora of content and service provider web-sites that users may access and interact with via a variety of user devices (e.g., mobile phones, tablets, etc.) However, the devices may have different operating systems, applications, or capabilities for effectuating the access to and interaction with the web content, wherein the differences in a user device may impact the device performance and user experience. For example, performance of a device may be less efficient when accessing web content with complex and potentially resource-intensive scripts (e.g., JavaScript (JS)) that provide advance web applications and/or functionality. Accordingly, service providers and device manufacturers face significant technical challenges to overcome such limitations by efficient processing, tracking, and responding to user interactions with web contents.

### Some Exemplary Embodiments

Therefore, there is a need for an approach for temporal registration of modifications in a document object model (DOM) and providing an efficient update to the DOM.

According to one embodiment, a method comprises processing and/or facilitating a processing of event data resulting from at least one interaction with a document object model to determine at least one modification to at least one node of the document object model. The method also comprises causing, at least in part, a registration of the at least one modification with respect to a temporal parameter. Further, the method comprises causing, at least in part, a generation of at least one content change result list for the document object model based, at least in part, on the registration. Furthermore, the method comprises causing, at least in part, a transmission of the at least one content change result list to at least one proxy client for updating of the document object model.

According to another embodiment, an apparatus comprises at least one processor, and at least one memory including computer program code for one or more programs, the at least one memory and the computer program code configured to, with the at least one processor, cause, at least in part, the apparatus to process and/or facilitate a processing of event data resulting from at least one interaction with a document object model to determine at least one modification to at least one node of the document object model. The apparatus is also caused to cause, at least in part, a registration of the at least one modification with respect to a temporal parameter. Further, the apparatus is caused to cause, at least in part, a generation of at least one content change result list for the document object model based, at least in part, on the registration. Furthermore, the apparatus is caused to cause, at least in part, a transmission of the at least one content change result list to at least one proxy client for updating of the document object model.

According to another embodiment, a computer-readable storage medium carries one or more sequences of one or more instructions which, when executed by one or more processors, cause, at least in part, an apparatus to process and/or facilitate a processing of event data resulting from at least one interaction with a document object model to determine at least one modification to at least one node of the document object model. The apparatus is also caused to cause, at least in part, a registration of the at least one modification with respect to a temporal parameter. Further, the apparatus is caused to cause, at least in part, a generation of at least one content change result list for the document object model based, at least in part, on the registration. Furthermore, the apparatus is caused to cause, at least in part, a transmission of the at least one content change result list to at least one proxy client for updating of the document object model.

According to another embodiment, an apparatus comprises means for processing and/or facilitating a processing of event data resulting from at least one interaction with a document object model to determine at least one modification to at least one node of the document object model. The apparatus also comprises means for causing, at least in part, a registration of the at least one modification with respect to a temporal parameter. Further, the apparatus comprises means for causing, at least in part, a generation of at least one content change result list for the document object model based, at least in part, on the registration. Furthermore, the apparatus comprises means for causing, at least in part, a transmission of the at least one content change result list to at least one proxy client for updating of the document object model.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of temporal registration of modifications in a DOM and providing an efficient update to a DOM, according to an embodiment;

FIG. 2 is a diagram of components of a proxy platform for registering modifications in a DOM and providing partial updates, according to an embodiment;

FIGS. 3 and 4 are flowcharts of various processes for, at least, temporal registration of modifications in a DOM and providing an efficient update to the DOM, according to various embodiments;

FIG. 5 is a time-sequence diagram depicting a traditional process for providing a DOM to a proxy client, according to an example;

FIGS. 6 and 7 depict various processes for providing a partial DOM update to a proxy client, according to various embodiments;

FIG. 8 is a diagram depicting a DOM comparison for performing partial updates, according to an embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile station (e.g., handset) that can be used to implement an embodiment of the invention.

### DESCRIPTION OF PREFERRED EMBODIMENT

A method and apparatus for temporal registration of modifications in a DOM and providing an efficient update to the DOM are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect temporal registration of modifications in a DOM and providing an efficient update to the DOM within a wireless network environment, it is contemplated that the various embodiments of the approach described herein may be used within any type of communication system or network and with any mode of communication available in the network (e.g., data communications, Internet communication, voice communication, text communication, etc.) In addition, although the various embodiments are further described with respect to mobile devices, it is contemplated that the various embodiments are applicable to any type of device with network access (e.g., stationary terminals, personal computers, etc.)

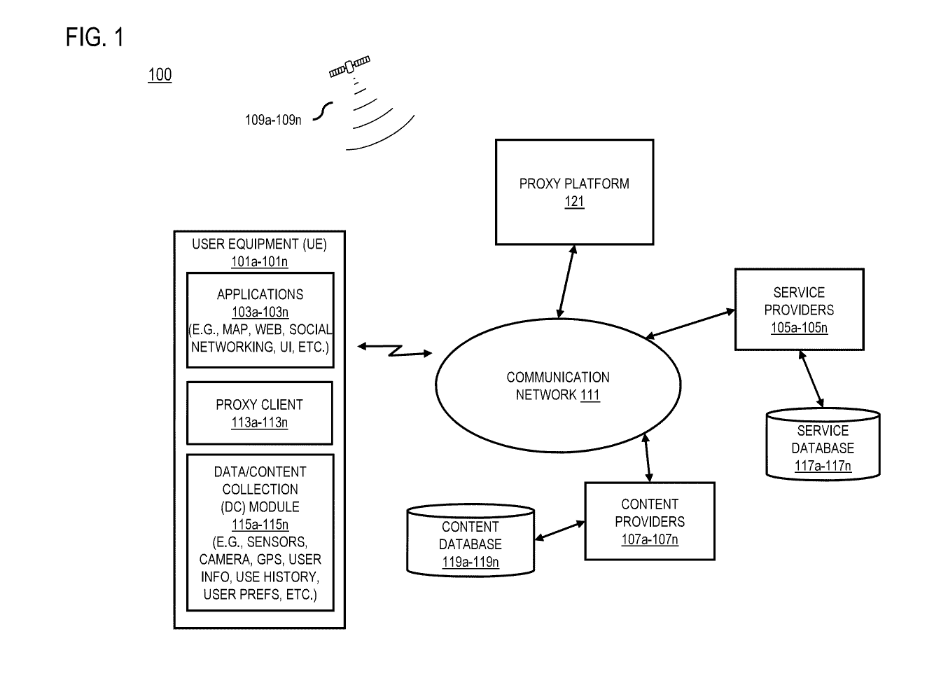

FIG. 1 is a diagram of a system capable of temporal registration of modifications in a DOM and providing an efficient update to a DOM, according to an embodiment. As discussed previously, users may utilize a variety of devices for accessing and interacting with web contents that may be available from various online service and content providers, where in many cases the devices are various mobile devices (e.g., tablets, mobile phones, etc.) that provide access to the web contents via wireless communication services. However, implementing mobile web services within a wireless environment can potentially tax the relatively limited resources (e.g., bandwidth, processing power, memory, battery power, etc.) that are available within the environment (e.g., within a mobile device). Moreover, as web-based applications become more sophisticated by employing the latest web technologies (e.g., scripting via languages such as JS), the problem of having sufficient resources at mobile devices to support new applications also increases. One traditional way to address this problem is use of a proxy web browser. By way of example, in a proxy browser, a user's (client's) interactions with web contents, e.g., in a DOM, may be sent to a server where the appropriate actions are taken (e.g., process a request for an updated content item) and new or modified content is sent back to the client device for display. Further, in using a standard browser rendering engine, a challenge to produce a DOM is that a standard browser is designed to return only full DOMs. However, if a full DOM is sent to a DOM comparator (e.g., at the client, at a proxy server, etc.) after each client interaction, the comparisons may begin to degrade after few interactions since; for example, an insertion of new content affects style computation, which in turn can affect a percentage of the DOM that remains the same from one client interaction to the next.

To address this problem, a system 100 of FIG. 1 introduces the capability for temporal registration of modifications in a DOM and providing an efficient update to the DOM. In general, a more efficient method for rendering updates to a DOM can be via a web-content rendering engine where it can systematically detect changes, triggered by a user interacting with web content (e.g., a web page), in the order in which they occur. Then the output of the web-rendering engine may be communicated to a service (e.g., a proxy server) with a DOM comparator, which can determine the smallest possible change for sending to the client device. In one embodiment, the method may include for a browser rendering engine to temporally register each modification to the DOM. For instance, each partial change, e.g., mutated nodes, in a DOM would be registered with respect to time, rather than with respect to its top-to-bottom location in the DOM. This modified identification and registration mechanism can result in a list of partial DOM changes which can be further processed by a DOM comparator algorithm. The temporal ordering of the content modifications can result in a more compact change list that could, at least, provide for a more efficient use of resources and bandwidth for a faster transmission of the updated web content to a client.

In one embodiment, the system 100 may process and/or facilitate a processing of event data resulting from at least one interaction with a document object model to determine at least one modification to at least one node of the document object model. In one embodiment, a user or an application at a device (e.g., a mobile device) may cause a submission of a request for access to a web content available via a service or a content provider web page. For example, a user may utilize a web browser application for accessing a website. In one embodiment, the interaction may be with a web content already at the device where the interaction may be with a content item within the web content. For example, a user may click/press on a link within a webpage already loaded at the device. In one embodiment, a proxy platform may process the interaction to determine a modification to one or more nodes in a DOM. In one example, a modification in a DOM may be associated with a node providing textual information for a web content item.

In one embodiment, the system 100 may cause, at least in part, a registration of the at least one modification with respect to a temporal parameter. In one embodiment, the proxy platform may register each modification as the modification is detected in the DOM. For example, the modifications are registered and logged according to the time sequence that they were detected in the DOM.

In one embodiment, the system 100 may cause, at least in part, a generation of at least one content change result list for the document object model based, at least in part, on the registration. For example, the proxy platform may generate a list including the temporal notifications detected in the DOM. In one embodiment, the at least one content change result list specifies, at least in part, one or more mutated nodes in the document object model. In one embodiment, the one or more mutated nodes are registered by one or more mutation event listeners for determining at least one least-sized sub-tree including the one or more mutated nodes.

In one embodiment, the system 100 may cause, at least in part, a transmission of the at least one content change result list to at least one proxy client for updating of the document object model. In one embodiment, the proxy platform may transmit the content change result list to a user device including the proxy client application. In one embodiment, the updating of the document object model includes causing, at least in part, a comparison of a first version of the document object model before the at least one interaction and a second version of the document object model after the at least one interaction. In one scenario, the proxy platform may cause a comparison of an original DOM and a modified DOM for updating a DOM to a proxy client.

In one embodiment, the system 100 may determine whether to initiate a full update of the document object model or a partial update of the document object model based, at least in part, on a size of the at least one content change result list. In one embodiment, a proxy platform may calculate the size of the content change result list based on digital size of the list. For example, a size of the file on the content change result list. In one embodiment, the proxy platform may utilize a threshold for the size of the content change result list in order to determine whether to initiate a full or a partial update of the DOM. For example, if the size of the content change result list is greater than a certain threshold value, then the DOM will be fully updated instead of a partial update.

In one embodiment, the system 100 may determine whether to initiate a full update of the document object model or a partial update of the document object model based, at least in part, on a number of the one or more mutated nodes. In one embodiment, the proxy platform may determine the number of mutated nodes in the modified DOM and then based on a threshold for the number of mutated nodes, the proxy platform may determine whether to initiate a full or a partial update of the DOM. For example, if there are a greater number of mutated nodes compared to the threshold value, then the DOM will be fully updated instead of a partial update.

In one embodiment, the system 100 may determine whether to initiate a full update of the document object model or a partial update of the document object model based, at least in part, on a ratio of the one or more mutated nodes to one or more unmutated nodes of the document object model. In one embodiment, the proxy platform may utilize a threshold value for a ratio between the mutated nodes and the unmutated nodes for determining a full update or a partial update to the DOM. For example, if the ratio is above a certain percentage (e.g., more mutated nodes compared to the unmutated nodes), the full updated DOM may be generated and transmitted to the proxy client.

In one embodiment, the system 100 may cause, at least in part, a sorting of the one or more mutated nodes by a temporal order based, at least in part, on the registration to cause, at least in part, the generation of the at least one content change result list. For example, the proxy platform may perform a sorting on the generated content change result list where the mutated nodes are sorted by the time sequence for rendering a temporal ordered list of mutated nodes.

In one embodiment, the system 100 may determine the size of the at least one content change result list based, at least in part, on one or more respective sizes of one or more sub-trees associated with the one or more mutated nodes. In one scenario, a content change result list may include a plurality of mutated nodes forming a plurality of sub-trees, wherein the size of a sub-tree in a modified DOM may be compared to that of in the original DOM. In one embodiment, a modification to a sub-tree may be due to an insertion or a removal of nodes in the original DOM sub-trees.

In one embodiment, the system 100 may determine a threshold value for a continuation of the registration of the at least one modification based, at least in part, on at least one content type associated with the document object model, available resources at the proxy client, a bandwidth for the transmission of the at least one content change result list, a ratio of a number of one or more nodes in the DOM before the at least one modification to a number of one or more nodes in the content change result list, or a combination thereof. In one embodiment, the proxy platform and determine whether to continue the registration of the modifications in a DOM based on a type of content associated with the DOM; for example, a content type may be determined from the DOM. In one example, the resources available at a user device may be considered when determining whether to continue the registration of the modifications for a partial DOM update. In another example, the bandwidth available for transmitting the content change list may be considered for registering the modifications to a DOM. In one embodiment, the threshold may be determined based, at least in part, on a ratio of the number of nodes in a DOM before any modifications in the DOM to the number of nodes in the content change result list.

In one use case scenario, a web application/website, which may provide certain contents (e.g., advertising, notifications, etc.), wherein the web application API may require loading of a JS file available from the content provider (e.g., <script src=“adscript.js”>). In one example, the “adscript.js” may cause a search for a tag with an ID set to ‘ad’, which it then dynamically adds an image tag into and updates every 30 seconds via a JS timer (e.g., a ‘rotating’ ad). In a proxy browsing solution, an update every 30 seconds may require a new image to be sent to a proxy client (e.g., at a user device) during every round trip communication with the content provider (e.g., server). However, since digital image files are large, when compared to partial page content update, every update can cause in less desirable user experience, for example, due to a slow communication network, data consumption charges, etc. In one scenario, partial page updates to anything in an “ad” div-tag may be deferred while the content (e.g., the ad) may still be there, but it will appear to rotate/update less frequently than 30 seconds.

In one example, a proxy server runtime framework could assign a special meaning to an “onlyAllowPartialPageUpdate” attribute so that it may allow partial page updates to the content of the div-tag every 120 seconds at the minimum, which on average may cause an update to the content on every fourth or fifth roundtrip to the server.

In one example, the “onlyAllowPartialPageUpdate” attribute may be set such that a value assigned could be a maximum frequency of round trips to the server, for instance, a setting at four can cause an update to the content every fourth time when communicating with the server.

In one scenario, the attribute may be implemented via a built-in JS function in a JS runtime of a proxy server, for example:
document.getElementById(‘ad’).setOnlyAllowPartialPageUpdate(120)

In one use case scenario, a web application for providing notifications (e.g., a commodity market information web-app) may include a line-chart of several data items that are updated per-minute. Further, a data provider may insert the images and text into the content via a JS file that are included by the web application. In one case, for a more efficient application performance and user experience, the proxy server can determine an interaction with a certain content item and avoid inadvertent trigger of updates to the image and text for the other content items. In one embodiment, contents in a div-tag may be associated with a special proxy-based HTML attribute or use a proxy-based JS function to improve the usability and update frequency of the content.

In various examples, the methods discussed can allow a proxy web application to take advantage of third-party data sources and mitigate performance problems associated with third-party APIs, where the third-party APIs may have been designed in a way that could require more bandwidth and resources than a user device and network elements may be able to efficiently process. Another advantage may be realized when the methods may be implemented without a need for a web application developer to reverse-engineer a third-party API.

As shown in FIG. 1, in one embodiment, the system 100 includes user equipment 101a-101n (also collectively referred to as UE 101 and/or UEs 101), which may be utilized to execute one or more applications 103a-103n (also collectively referred to as applications 103) including social networking, web browser, content sharing, multimedia applications, augmented reality (AR), virtual reality (VR), user interface (UI), map application, web client, etc.

Additionally, the applications 103 may facilitate communication with other UEs 101, one or more service providers 105a-105n (also collectively referred to as service providers 105), one or more content providers 107a-107n (also collectively referred to as content providers 107), one or more GPS satellites 109a-109n (also collectively referred to as GPS satellites 109), a proxy platform 121, and/or with other components of the system 100 directly and/or via communication network 111. In one embodiment, the UEs 101 may include proxy clients 113a-113n (also collectively referred to as proxy client 113), and data/content collection modules 115a-115n (also collectively referred to as DC module 115).

In one embodiment, a proxy client 113 may route at least a portion of communication data from a UE 101 to the proxy platform 121. In some embodiments, the proxy clients 113 may be implemented in the applications 103, e.g., in a browser application. In addition or alternatively, the proxy clients 113 may be independent processes executing at the UEs 101.

In one embodiment, the proxy platform 121 may receive a request from the proxy clients 113 to route communication data to the intended communication endpoints. In addition, the proxy platform 121 may route return communication data from the communication endpoints to the proxy client 113 and/or applications 103. By way of example, the communication endpoints may include a service provider 105, a content provider 107, or any other component with connectivity to the communication network 111 (e.g., another UE 101). For example, the service provider 105 or the content provider 107 may provide any number of services (e.g., mapping services, social networking services, media services, content services, etc.) via a web server or other means of communications (e.g., text messaging, voice, instant messaging, chat, etc.) By way of example, the communication endpoints may be a terminating point of communications from the proxy clients 113 and an originating point of communications to the proxy clients 113.

In some embodiments, the proxy platform 121 may receive requests from the proxy clients 113 to access a web service, such as a webpage, web application, or other web contents, and the proxy platform 121 may perform any number of communications related functions for routing and/or processing the resulting communication data. For example, as noted above, the proxy platform 121 can provide an optimized content delivery process by providing partial updates based on mutations or differences in a DOM associated with a web content item. In other embodiments, the proxy platform 121 may compress or otherwise modify content that is to be delivered to the proxy clients 113 based, at least in part, on one or more capabilities or characteristics of the receiving UEs 101. For example, in wireless environments, the proxy platform 121 can compress data for more efficient transmission, transform content to reduce the amount of data for transfer, reformat content for display in smaller screens, change the content to an image file, etc. The proxy platform 121 may divide the service content into a series of subparts that may be equally or unequally parsed and sent to the UE 101 like a deck of cards based on any of the display capabilities or resolution of a display, available memory, a battery condition, and/or available power mode settings of the UE 101.

In one embodiment, the DC module 115 may be used for determining and/or collecting data and/or content associated with the UEs 101, one or more users of the UEs 101, applications 103, one or more content items (e.g., multimedia content), and the like. In addition, the UEs 101 can execute an application 103 that is a software client for storing, processing, and/or forwarding one or more information items to other components of the system 100.

In one embodiment, the service providers 105 may include and/or have access to one or more service databases 117a-117n (also collectively referred to as service database 117), which may include various user information, user profiles, user preferences, one or more profiles of one or more user devices (e.g., device configuration, sensors information, etc.), service providers 105 information, other service providers' information, and the like. In one embodiment, the service providers 105 may include one or more service providers offering one or more services, for example, online shopping, social networking services (e.g., blogging), content sharing, media upload, media download, media streaming, account management services, or a combination thereof.

In one embodiment, the content providers 107 may include and/or have access to one or more content database 119a-119n (also collectively referred to as content database 119), which may store, include, and/or have access to various content items. For example, the content providers 107 may store content items (e.g., at the content database 119) provided by various users, various service providers, crowd-sourced content, and the like. Further, the service providers 105 and/or the content providers 107 may utilize one or more service application programming interfaces (APIs)/integrated interface, through which communication, notifications, updates, content, and information (e.g., associated with users, applications, services, content, etc.) may be shared, accessed and/or processed.

The UEs 101 may be any type of mobile terminal, fixed terminal, or portable terminal including a mobile handset, station, unit, device, healthcare diagnostic and testing devices, product testing devices, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, loud speakers, display monitors, radio broadcast receiver, electronic book device, game device, wrist watch, or any combination thereof, including the accessories and peripherals of these devices, or any combination thereof. It is also contemplated that the UEs can support any type of interface to the user (such as “wearable” circuitry, etc.) Further, the UEs 101 may include various sensors for collecting data associated with a user, a user's environment, and/or with a UE 101, for example, the sensors may determine and/or capture audio, video, images, atmospheric conditions, device location, user mood, ambient lighting, user physiological information, device movement speed and direction, and the like.

In one embodiment, the UE 101 includes a location module/sensor that can determine the UE 101 location (e.g., a user's location). The UE 101 location may be determined by a triangulation system such as a GPS, assisted GPS (A-GPS), Cell of Origin, wireless local area network triangulation, or other location extrapolation technologies. Standard GPS and A-GPS systems can use the one or more satellites 109 to pinpoint the location (e.g., longitude, latitude, and altitude) of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module/sensor may also utilize multiple technologies to detect the location of the UE 101. GPS coordinates can provide finer detail as to the location of the UE 101. In another embodiment, the UE 101 may utilize a local area network (e.g., LAN, WLAN) connection to determine the UE 101 location information, for example, from an Internet source (e.g., a service provider).

By way of example, the communication network 111 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the UEs 101, the service providers 105, the content providers 107, and the proxy platform 121 may communicate with each other and other components of the communication network 111 using well known, new or still developing protocols. In this context, a protocol includes a set of rules defining how the network nodes within the communication network 111 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, the UEs 101, the service providers 105, the content providers 107, and the proxy platform 121 may interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. It is also noted that the role of a client and a server is not fixed; in some situations a device may act both as a client and a server, which may be done simultaneously and/or the device may alternate between these roles.

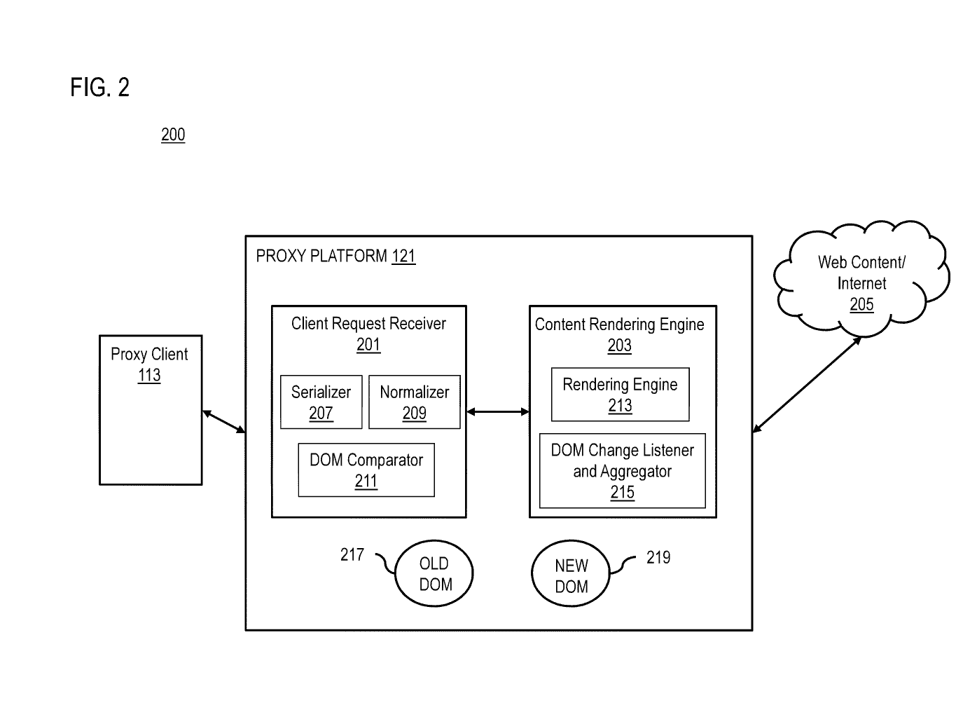

FIG. 2 is a diagram of components of a proxy platform for registering modifications in a DOM and providing partial updates, according to an embodiment. In one embodiment, the proxy platform 121 may include a client request receiver 201 and a content rendering engine 203, wherein the proxy platform may utilize various processes and algorithms for effectuating an access from the proxy client 113 (e.g., at a UE 101) to the web content/Internet 205 (e.g., at a service/content provider). In one embodiment, the client request receiver 201 may include a serializer 207, a normalizer 209, and a DOM comparator 211. Further, the content rendering engine 203 may include a rendering engine 213 and a DOM change listener and aggregator 215. It is noted that the components in the proxy platform 121 may be implemented in various configurations where one or more components may be used interchangeably or substituted for another. As previously described, the proxy platform 121 can perform partial DOM updates in response to client interaction events to, for instance, reduce the amount of data that is transmitted to the proxy client 113 if a callback changes only a portion of the DOM or the requested web content.

In one embodiment, building a partial page response is based, at least in part, on determining how the web content request has changed the web content or the old DOM 217. By way of example, this may be accomplished by saving a copy of the DOM before a callback request is executed, old DOM 217. The DOM comparator 211 can then compare the old DOM 217 with the new DOM 219 after the callback request is processed. In one embodiment, the DOM comparator 211 may use an algorithm to recursively walk through the two DOMs 217 and 219 in parallel looking for any modifications and temporally registering them into a change result list. Although, the description below is with respect to a particular algorithm, it is contemplated that the DOM comparator 211 may use any process to determine differences between the DOMs 217 and 219. When a node of the two DOMs 217 and 219 are identified as different, the DOM comparator 211 can search for an ancestor node in the new DOM 219 with an ID attribute (by returning from the recursion). If an ancestor node is found, then that node is added to a list of modified nodes.

In one embodiment, before a node is added to the modified node list, the DOM comparator 211 can prune from the list any subtending nodes already in the list. By way of example, the DOM comparator 211 does this by storing the size of the list when it starts recursively walking each node's children. The walk then continues with the parent node just added to the modified node list. It is noted that there is no reason to check any more children of the node added to the list because the child nodes would already be impacted.

In another embodiment, as the DOM comparator 211 compares the two DOMs 217 and 219 and keeps track of the number nodes in the new DOM 219 that have not changed and the number of nodes that subtend the list of modified nodes. The DOM comparator 211 can then use this information as one of the factors for determining whether a partial page update is recommended. In some embodiments, the DOM comparator 211 can ignore a subset of attributes and tags that are designated as not significant. In addition, the DOM comparator 211 can be configured to ignore nodes associated with insignificant whitespaces.

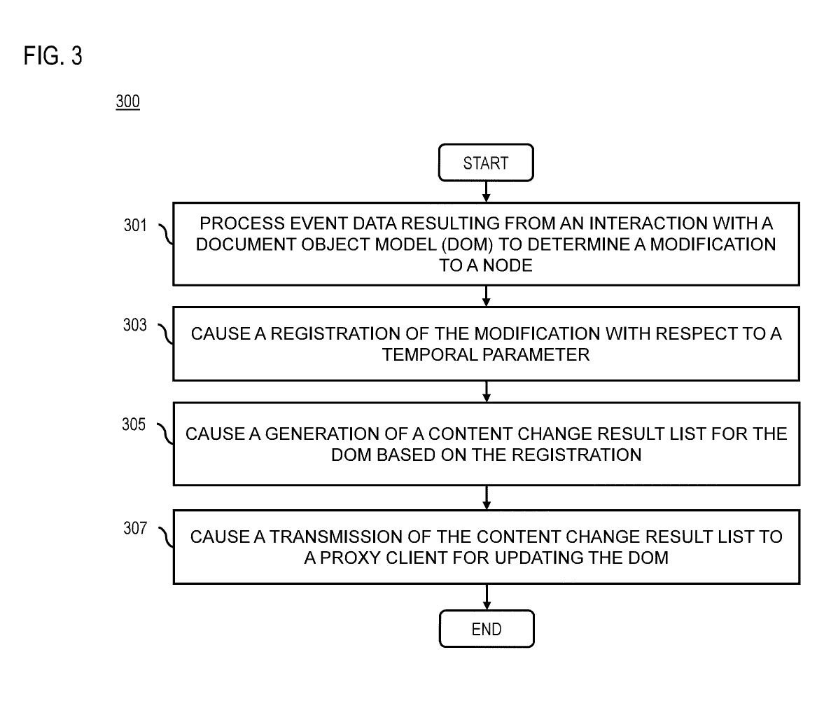

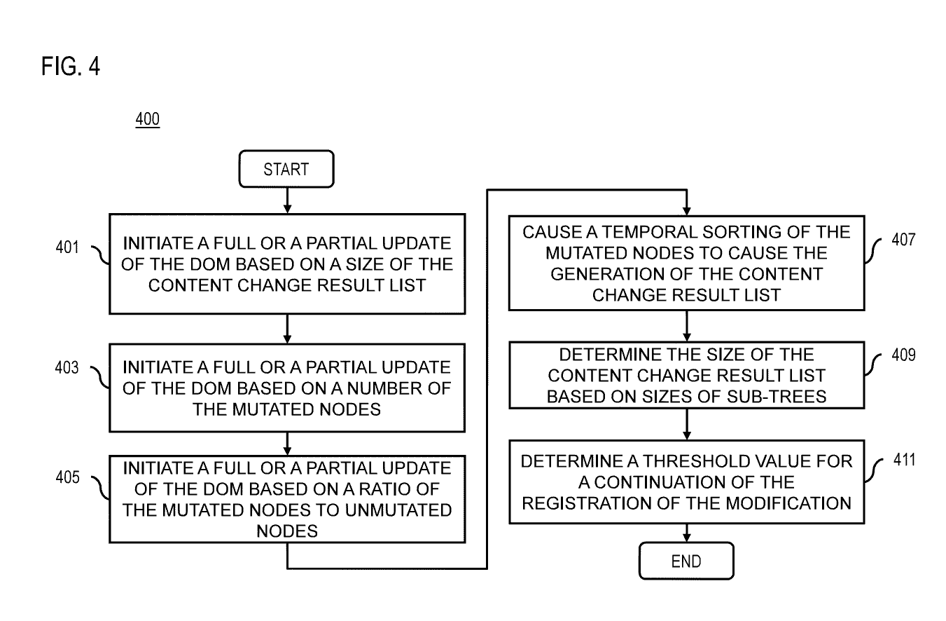

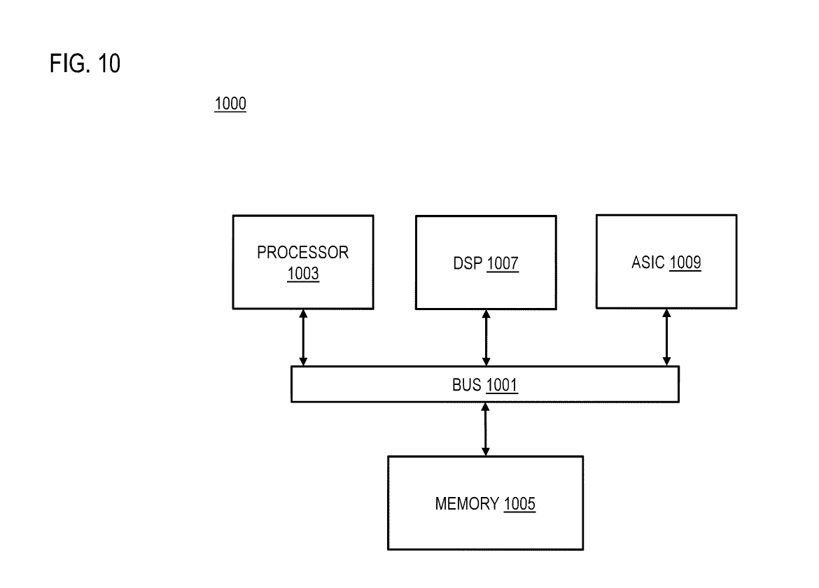

FIGS. 3 and 4 are flowcharts of various processes for, at least, temporal registration of modifications in a DOM and providing an efficient update to the DOM, according to various embodiments. In various embodiments, a proxy platform 121 may perform one or more portions of the processes 300 and 400 which may be implemented in, for instance, a chip set including a processor and a memory as shown in FIG. 10. As such, the proxy platform 121 can provide means for accomplishing various parts of the processes 300 and 400 600 as well as means for accomplishing other processes in conjunction with other components of the system 100. Throughout these processes, the a proxy platform 121 and/or a proxy client 113 may be referred to as completing various portions of the processes 300 and 400; however, it is understood that other components of the system 100 can perform some of and/or all of the process steps. Further, for clarity in discussing the processes 300 and 400, the proxy platform 121 is referred to as completing various steps of said processes; however, said processes and/or example steps described therein may be performed in any suitable order and/or may be optional.

The process 300 may begin at step 301 of the FIG. 3, where the proxy platform 121 may process and/or facilitate a processing of event data resulting from at least one interaction with a document object model to determine at least one modification to at least one node of the document object model. In one embodiment, a user or an application at a device (e.g., a mobile device) may cause a submission of a request for access to a web content available via a service or a content provider web page. For example, a user may utilize a web browser application for accessing a website. In one embodiment, the interaction may be with a web content already at the device where the interaction may be with a content item within the web content. For example, a user may click/press on a link within a webpage already loaded at the device. In one embodiment, a proxy platform may process the interaction to determine a modification to one or more nodes in a DOM. In one example, a modification in a DOM may be associated with a node providing textual information for a web content item.

In step 303, the proxy platform 121 may cause, at least in part, a registration of the at least one modification with respect to a temporal parameter. In one embodiment, the proxy platform may register each modification as the modification is detected in the DOM. For example, the modifications are registered and logged according to the time sequence that they were detected in the DOM.

In step 305, the proxy platform 121 may cause, at least in part, a generation of at least one content change result list for the document object model based, at least in part, on the registration. For example, the proxy platform may generate a list including the temporal notifications detected in the DOM. In one embodiment, the at least one content change result list specifies, at least in part, one or more mutated nodes in the document object model. In one embodiment, the one or more mutated nodes are registered by one or more mutation event listeners for determining at least one least-sized sub-tree including the one or more mutated nodes.

In step 307, the proxy platform 121 may cause, at least in part, a transmission of the at least one content change result list to at least one proxy client for updating of the document object model. In one embodiment, the proxy platform may transmit the content change result list to a user device including the proxy client application. In one embodiment, the updating of the document object model includes causing, at least in part, a comparison of a first version of the document object model before the at least one interaction and a second version of the document object model after the at least one interaction. In one scenario, the proxy platform may cause a comparison of an original DOM and a modified DOM for updating a DOM to a proxy client.

The process 400 may begin at step 401 of the FIG. 4, where the proxy platform 121 may determine whether to initiate a full update of the document object model or a partial update of the document object model based, at least in part, on a size of the at least one content change result list. In one embodiment, a proxy platform may calculate the size of the content change result list based on digital size of the list. For example, a size of the file on the content change result list. In one embodiment, the proxy platform may utilize a threshold for the size of the content change result list in order to determine whether to initiate a full or a partial update of the DOM. For example, if the size of the content change result list is greater than a certain threshold value, then the DOM will be fully updated instead of a partial update.

In step 403, the proxy platform 121 may determine whether to initiate a full update of the document object model or a partial update of the document object model based, at least in part, on a number of the one or more mutated nodes. In one embodiment, the proxy platform may determine the number of mutated nodes in the modified DOM and then based on a threshold for the number of mutated nodes, the proxy platform may determine whether to initiate a full or a partial update of the DOM. For example, if there are a greater number of mutated nodes compared to the threshold value, then the DOM will be fully updated instead of a partial update.

In step 405, the proxy platform 121 may determine whether to initiate a full update of the document object model or a partial update of the document object model based, at least in part, on a ratio of the one or more mutated nodes to one or more unmutated nodes of the document object model. In one embodiment, the proxy platform may utilize a threshold value for a ratio between the mutated nodes and the unmutated nodes for determining a full update or a partial update to the DOM. For example, if the ratio is above a certain percentage (e.g., more mutated nodes compared to the unmutated nodes), the full updated DOM may be generated and transmitted to the proxy client.

In step 407, the proxy platform 121 may cause, at least in part, a sorting of the one or more mutated nodes by a temporal order based, at least in part, on the registration to cause, at least in part, the generation of the at least one content change result list. For example, the proxy platform may perform a sorting on the generated content change result list where the mutated nodes are sorted by the time sequence for rendering a temporal ordered list of mutated nodes.

In step 409, the proxy platform 121 may determine the size of the at least one content change result list based, at least in part, on one or more respective sizes of one or more sub-trees associated with the one or more mutated nodes. In one scenario, a content change result list may include a plurality of mutated nodes forming a plurality of sub-trees, wherein the size of a sub-tree in a modified DOM may be compared to that of in the original DOM. In one embodiment, a modification to a sub-tree may be due to an insertion or a removal of nodes in the original DOM sub-trees.

In step 411, the proxy platform 121 may determine a threshold value for a continuation of the registration of the at least one modification based, at least in part, on at least one content type associated with the document object model, available resources at the proxy client, a bandwidth for the transmission of the at least one content change result list, a ratio of a number of one or more nodes in the DOM before the at least one modification to a number of one or more nodes in the content change result list, or a combination thereof. In one embodiment, the proxy platform and determine whether to continue the registration of the modifications in a DOM based on a type of content associated with the DOM; for example, a content type may be determined from the DOM. In one example, the resources available at a user device may be considered when determining whether to continue the registration of the modifications for a partial DOM update. In another example, the bandwidth available for transmitting the content change list may be considered for registering the modifications to a DOM. In one embodiment, the threshold may be determined based, at least in part, on a ratio of the number of nodes in a DOM before any modifications in the DOM to the number of nodes in the content change result list.

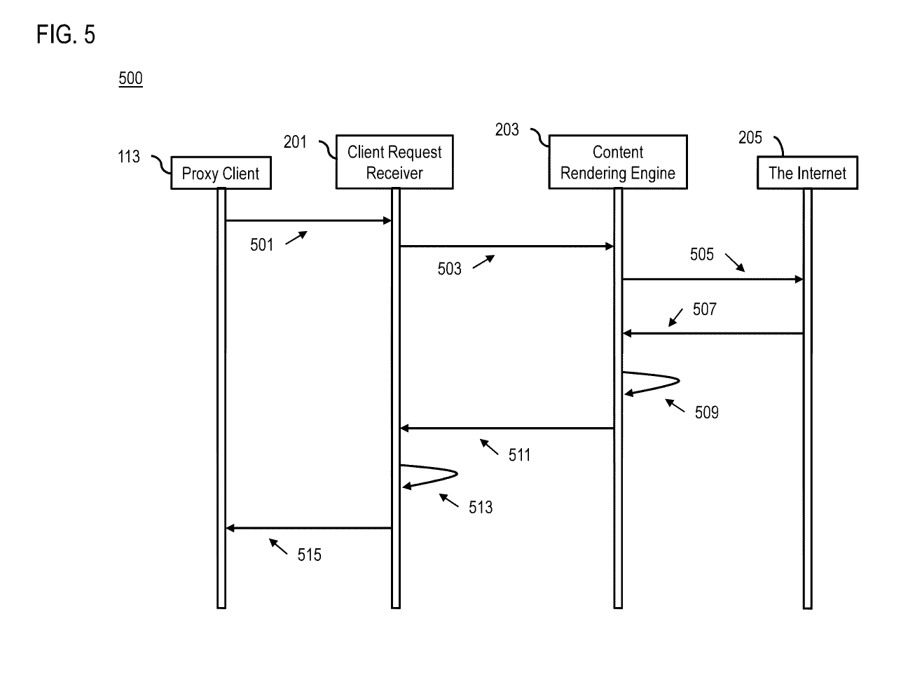

FIG. 5 is a time-sequence diagram depicting a traditional process for providing a DOM to a proxy client, according to an example.

In one scenario, a proxy client 113 (e.g., UE 101) may initiate a request for accessing web content, which is transmitted at 501 to a client request receiver 201. Further, the client request receiver 201 may process the request and transmit it at 505 to the content rendering engine 203, which may further process and submit the request to a service/content provider on the Internet 205. Furthermore, a service/content provider at 507 may return the requested content to the content rendering engine 203, which at 509 may generate an initial DOM for the web content and transmit it to the client request receiver at 511. In one example, the client request receiver 201 may further process and optimize the initial DOM at 513 before a new DOM is returned to the proxy client 113. In one example, the proxy client 113 and/or the applications 103 may process the new DOM at a UE 101 for rendering the requested web content.

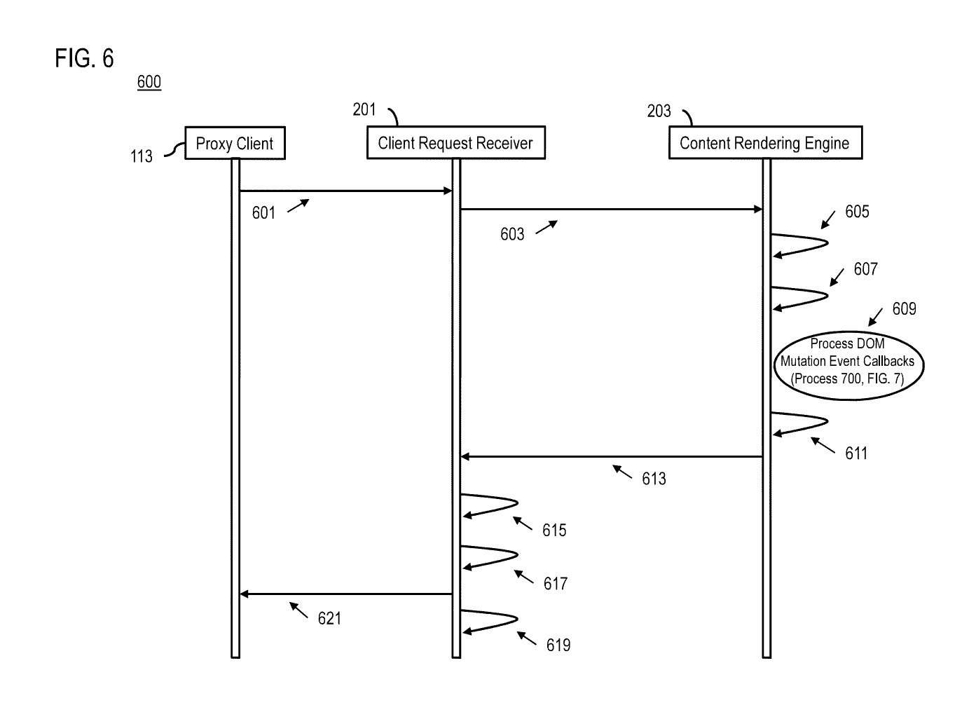

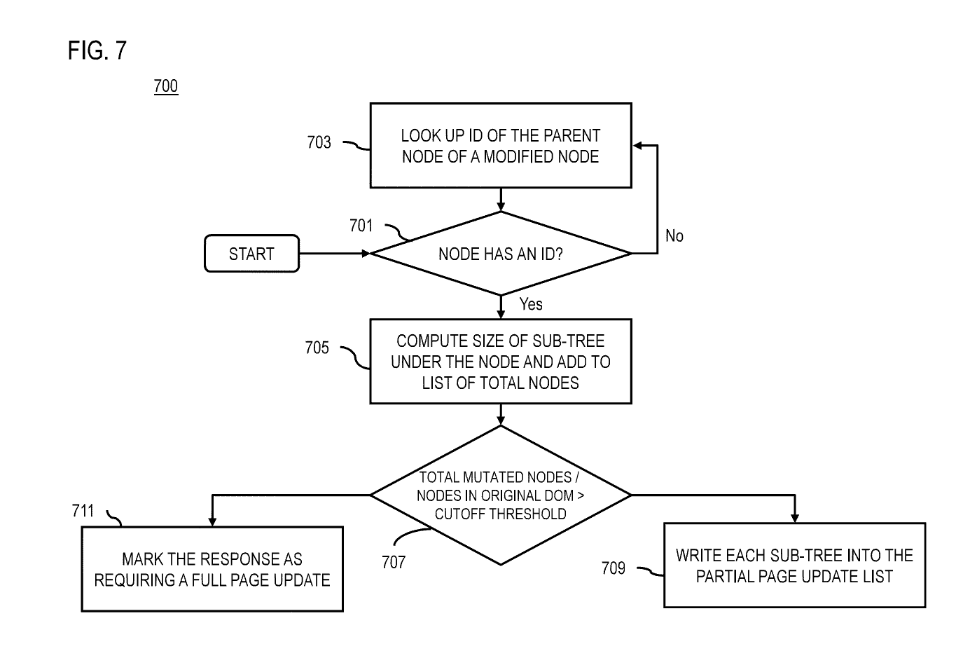

FIGS. 6 and 7 depict various processes for providing a partial DOM update to a proxy client, according to various embodiments.

FIG. 6 is a time-sequence diagram depicting a process for providing an updated DOM to a proxy client, according to an embodiment.

At 601, the proxy client 113 may detect an interaction with a DOM (e.g., a click on a DOM node) and transmit event data associated with that interaction to the client request receiver 201, which may process and/or for forward that event data at 603 to the content rendering engine 203. In one embodiment, at 605 the DOM change listener and aggregator 215 (e.g., in the content rendering engine 203) may register DOM mutation listeners for detecting any modifications to the DOM and then may submit the event data (e.g., JS event) to the rendering engine 213 (e.g., in the content rendering engine 203.) At 607, the rendering engine 213 may use change listener callbacks to determine each mutated nodes in a partial change in a modified DOM. Further, at 609, the content rendering engine 203 may utilize the processes detailed in FIG. 7 for the event listener callbacks.

Referring to FIG. 7, it includes a diagram of a process flow 700 for an event listener callback for determining one or more mutated nodes in the DOM. At 701, an event call back listener can determine whether an ancestor/parent node of a mutated node has an explicit identification (ID). If the parent node does not have an ID, then the process 700 may continue to step 703 to progress up the DOM tree to analyze the parent node's parent node and determine if it has an ID. The process 700 may continue recursively all the way up the hierarchical DOM tree until either a parent node with an ID is determined or the process may progress to the top of the DOM if no parent node with an ID is found. In one embodiment, if the process 700 progresses to the top of the DOM tree without having found a parent node with an ID, then the update to the DOM would be a full DOM update. However, if there is an ID associated with the parent node, the sub-tree starting at that parent node would contain one or more mutated nodes and potentially many other nodes. Then at 705, the size of all possible sub-trees including at least one mutated node is calculated (e.g., all nodes associated with that mutated node) and added to a list indicating a total of mutated nodes. In one embodiment, at 707, the total number of mutated nodes is compared to the total number of nodes in the original DOM. For example, a ratio can be calculated by dividing the total number of mutated nodes by the total number of nodes in the original DOM. In one embodiment, if the ratio is less or equal to a cutoff threshold, then at 709 each of the sub-trees would be written into a change result list for rendering a partial update DOM. However, if the ratio is higher than the cutoff threshold, then at 711 the content rendering engine 203 may mark a response as requiring a full page update.

Referring to FIG. 6 again, at 611 the event callback listeners may be unregistered and at 613, the temporal ordered change result list for rendering a partial page update is transmitted to the client request receiver 201, which at 615, may insert the partial page updates into a copy of the original DOM. At 617, the client request receiver may compare the newly modified DOM with the original DOM and then transmit the results of the DOMs comparison to the proxy client 113 so that an updated web content may be displayed. In one scenario, the newly modified DOM may be marked and be utilized as an original DOM for next use in the process 600.

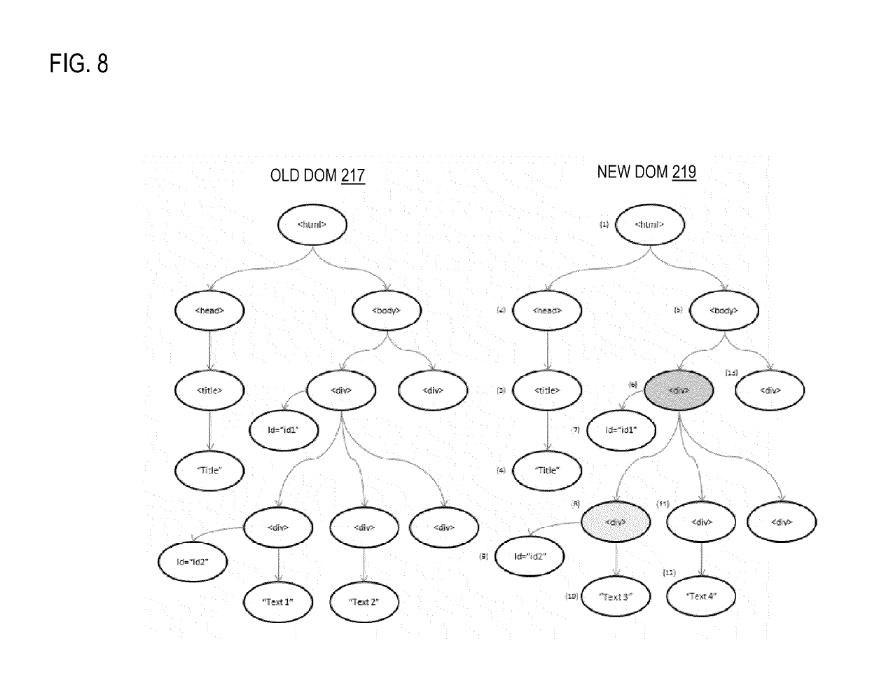

FIG. 8 is a diagram depicting a DOM comparison for performing partial updates, according to an embodiment. More specifically, FIG. 8 shows the structure of an old DOM 217 before a callback request and a new DOM 219 after the callback request is processed by the proxy platform 121. To perform a partial update, the proxy platform 121 identifies what has changed in the new DOM 219 and communicates this information to the proxy client 113.

A summary of how the DOM comparator 211 would identify the differences between the two DOMs 217 and 219 is summarized as follows:
Node (1) matches, continue with first (and only) child (2)
Node (2) matches, continue with first (and only) child (3)
Node (3) matches, continue with first (and only) child (4)
Node (4) matches, since no children return to the first ancestor node with another child (1) and proceed to its next child (5)
Node (5) matches, continue with first child (6)
Node (6) matches including its attribute node (7), continue with first child (8)
Node (8) matches including its attribute node (9), continue with first (and only) child (10)
Node (10) does not match:
   return to the first node with an id attribute (8)
   add (8) to the list
   return to that node's parent node (6)
   proceed with that nodes next child (11)
Node (11) matches, continue with first (only) child (12)
Node (12) does not match:
   return to the first node with an id attribute (6),
   remove the subtending node (8) from the list
   add (6) to the list
   return to that node's parent node (5)
   proceed with its next child (13)
   note that we did not visit the third child of node (6)
Node (13) matches, since no children return the first ancestor node with another child (there are not any)
Done.

In one embodiment, once the DOM comparator 211 has identified the nodes that have subtending changes, these changes are communication to the proxy client by sending the changes in, for instance, a set of MWL script commands (e.g., JS commands). By of example, each node with a subtending change adds an MWL “insertHTML” method call to the response. This method allows the proxy platform 121 to replace the existing HTML for a specified node with new HTML expressed as a string. The node to update is identified by its ID attribute. If the call back processing creates any new styles, then this is communicated to the proxy client 113 by adding an MWL “addNewStyle” method call to the response for each new style. The “addNewStyle” method calls are added to the response before the “insertHTML” method calls.

In one embodiment, if no changes are detected, then a response (e.g., a 204 HTTP NO CONTENT response) is sent to the proxy client 113. If the DOM comparator 211 determines that the changes so large (e.g., above a threshold value of modified nodes) that a partial page update is not desirable, then the proxy platform 121 can send a response that includes the HTML for the entire new page.

By way of example, when the proxy client 113 receives a callback response, the proxy client 113 will process it as appropriate. For example, if a 204 (HTTP NO CONTENT) response is received from the proxy platform 121, no additional changes will be done to the DOM on the proxy client 113. If the proxy platform 121 sent a partial page update to the proxy client 113, then the proxy client 113 will execute the MWL methods (e.g., “insertHTML” and “addNewStyle”) in the partial page update to the current DOM. If the proxy platform 121 response was the HTML for the entire new page, the client will replace the current DOM with the DOM corresponding to the new HTML. However, in some embodiments, the proxy client will keep using all of the media (e.g., images) from the old page, and all the MWL timers for the page will continue running

The processes described herein for temporal registration of modifications in a DOM and providing an efficient update to the DOM may be advantageously implemented via software, hardware, firmware, or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

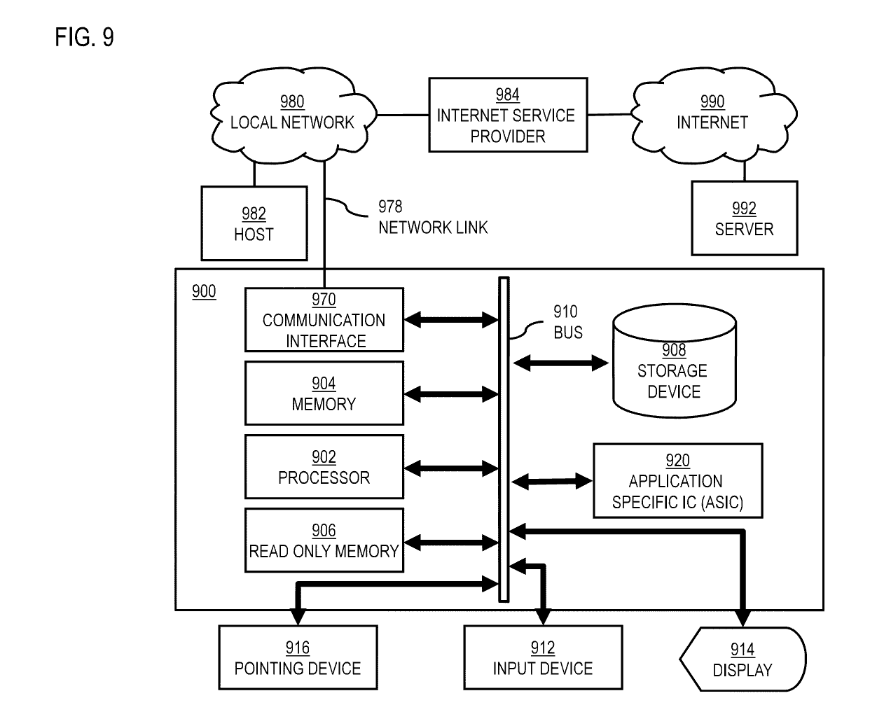

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to temporally register modifications in a DOM and providing an efficient update to the DOM as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of temporal registration of modifications in a DOM and providing an efficient update to the DOM.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to temporal registration of modifications in a DOM and providing an efficient update to the DOM. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for temporal registration of modifications in a DOM and providing an efficient update to the DOM. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for temporal registration of modifications in a DOM and providing an efficient update to the DOM, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914, and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners, and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic, or electromagnetic signals, including infrared and optical signals that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 111 for temporal registration of modifications in a DOM and providing an efficient update to the DOM.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980, and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed for temporal registration of modifications in a DOM and providing an efficient update to the DOM as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of temporal registration of modifications in a DOM and providing an efficient update to the DOM.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to temporally register modifications in a DOM and providing an efficient update to the DOM. The memory 1005 also stores the data associated with or generated by the execution of the inventive steps.

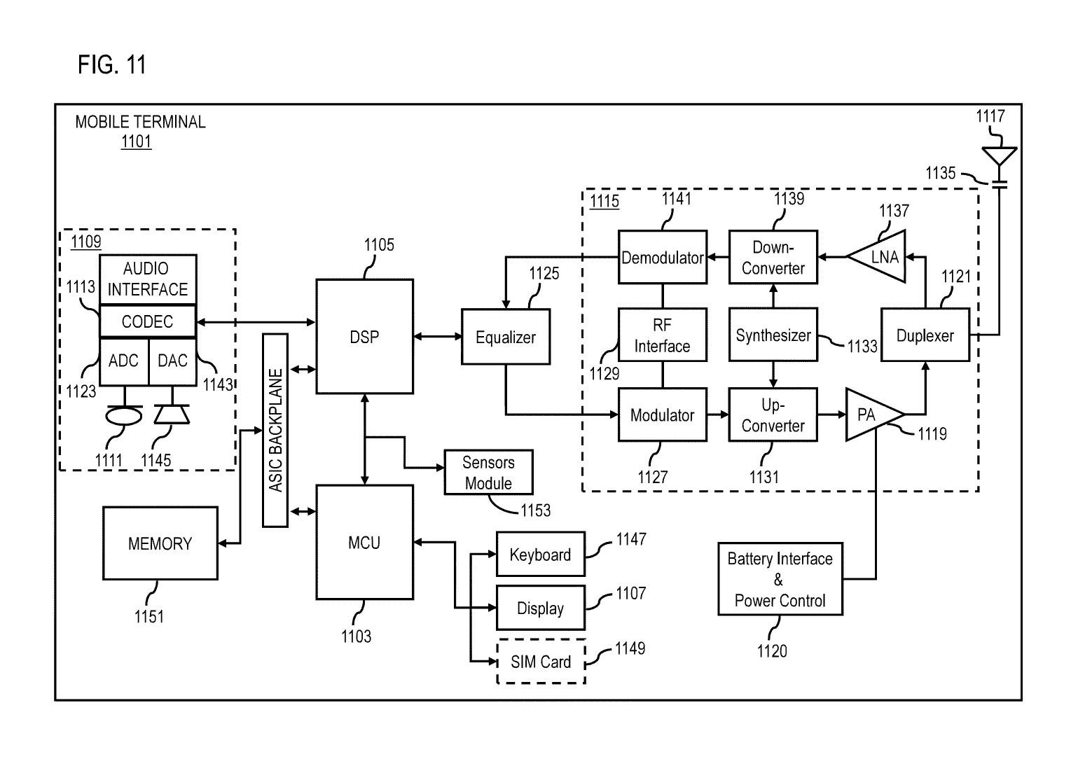

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of temporal registration of modifications in a DOM and providing an efficient update to the DOM. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of temporal registration of modifications in a DOM and providing an efficient update to the DOM. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 for temporal registration of modifications in a DOM and providing an efficient update to the DOM. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Additionally, sensors module 1153 may include various sensors, for instance, a location sensor, a speed sensor, an audio sensor, an image sensor, a brightness sensor, a biometrics sensor, various physiological sensors, a directional sensor, and the like, for capturing various data associated with the mobile terminal 1101 (e.g., a mobile phone), a user of the mobile terminal 1101, an environment of the mobile terminal 1101 and/or the user, or a combination thereof, wherein the data may be collected, processed, stored, and/or shared with one or more components and/or modules of the mobile terminal 1101 and/or with one or more entities external to the mobile terminal 1101.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a processing of event data resulting from at least one interaction with a document object model to determine at least one modification to at least one node of the document object model;
a registration of the at least one modification with respect to a temporal parameter;
a generation of at least one content change result list for the document object model based, at least in part, on the registration; and
a transmission of the at least one content change result list to at least one proxy client for updating of the document object model.

2. A method of claim 1, wherein the (1) data and/or (2) information and/or (3) at least one signal are further based, at least in part, on the following:
at least one determination of whether to initiate a full update of the document object model or a partial update of the document object model based, at least in part, on a size of the at least one content change result list.

3. A method of claim 1, wherein the at least one content change result list specifies, at least in part, one or more mutated nodes in the document object model.

4. A method of claim 3, wherein the (1) data and/or (2) information and/or (3) at least one signal are further based, at least in part, on the following:
at least one determination of whether to initiate a full update of the document object model or a partial update of the document object model based, at least in part, on a number of the one or more mutated nodes.

5. A method of claim 3, wherein the (1) data and/or (2) information and/or (3) at least one signal are further based, at least in part, on the following:
at least one determination of whether to initiate a full update of the document object model or a partial update of the document object model based, at least in part, on a ratio of the one or more mutated nodes to one or more unmutated nodes of the document object model.

6. A method of claim 3, wherein the (1) data and/or (2) information and/or (3) at least one signal are further based, at least in part, on the following:
a sorting of the one or more mutated nodes by a temporal order based, at least in part, on the registration to cause, at least in part, the generation of the at least one content change result list.

7. A method of claim 3, wherein the (1) data and/or (2) information and/or (3) at least one signal are further based, at least in part, on the following:
at least one determination of the size of the at least one content change result list based, at least in part, on one or more respective sizes of one or more sub-trees associated with the one or more mutated nodes.

8. A method of claim 3, wherein the one or more mutated nodes are registered by one or more mutation event listeners for determining at least one least-sized sub-tree including the one or more mutated nodes.

9. A method of claim 1, wherein the (1) data and/or (2) information and/or (3) at least one signal are further based, at least in part, on the following:
at least one determination of a threshold value for a continuation of the registration of the at least one modification based, at least in part, on at least one content type associated with the document object model, available resources at the proxy client, a bandwidth for the transmission of the at least one content change result list, a ratio of a number of one or more nodes in the DOM before the at least one modification to a number of one or more nodes in the content change result list, or a combination thereof.

10. A method of claim 1, wherein the updating of the document object model includes causing, at least in part, a comparison of a first version of the document object model before the at least one interaction and a second version of the document object model after the at least one interaction.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of event data resulting from at least one
interaction with a document object model to determine at least one modification to at least one node of the document object model;
cause, at least in part, a registration of the at least one modification with respect to a temporal parameter;
cause, at least in part, a generation of at least one content change result list for the document object model based, at least in part, on the registration; and
cause, at least in part, a transmission of the at least one content change result list to at least one proxy client for updating of the document object model.

12. An apparatus of claim 11, wherein the apparatus is further caused to:
determine whether to initiate a full update of the document object model or a partial update of the document object model based, at least in part, on a size of the at least one content change result list.

13. An apparatus of claim 11, wherein the at least one content change result list specifies, at least in part, one or more mutated nodes in the document object model.

14. An apparatus of claim 13, wherein the apparatus is further caused to:
determine whether to initiate a full update of the document object model or a partial update of the document object model based, at least in part, on a number of the one or more mutated nodes.

15. An apparatus of claim 13, wherein the apparatus is further caused to:
determine whether to initiate a full update of the document object model or a partial update of the document object model based, at least in part, on a ratio of the one or more mutated nodes to one or more unmutated nodes of the document object model.

16. An apparatus of claim 13, wherein the apparatus is further caused to:
cause, at least in part, a sorting of the one or more mutated nodes by a temporal order based, at least in part, on the registration to cause, at least in part, the generation of the at least one content change result list.

17. An apparatus of claim 13, wherein the apparatus is further caused to:
determine the size of the at least one content change result list based, at least in part, on one or more respective sizes of one or more sub-trees associated with the one or more mutated nodes.

18. An apparatus of claim 13, wherein the one or more mutated nodes are registered by one or more mutation event listeners for determining at least one least-sized sub-tree including the one or more mutated nodes.

19. An apparatus of claim 11, wherein the apparatus is further caused to:
determine a threshold value for a continuation of the registration of the at least one modification based, at least in part, on at least one content type associated with the document object model, available resources at the proxy client, a bandwidth for the transmission of the at least one content change result list, a ratio of a number of one or more nodes in the DOM before the at least one modification to a number of one or more nodes in the content change result list, or a combination thereof.

20. An apparatus of claim 11, wherein the updating of the document object model includes causing, at least in part, a comparison of a first version of the document object model before the at least one interaction and a second version of the document object model after the at least one interaction.

21-48. (canceled)
